(19) United States
(12) Patent Application Publication
(10) Pub. No.: US 2023/0041516 A1
(43) Pub. Date: Feb. 9, 2023

(54) HIGHLY PERMEABLE ULTRATHIN POLYMER NANOFILM COMPOSITE MEMBRANE AND A PROCESS FOR PREPARATION THEREOF

(71) Applicant: Council of Scientific & Industrial Research, New Delhi (IN)

(72) Inventors: Santanu Karan, Gujarat (IN); Pulak Sarkar, Gujarat (IN); Solagna Modak, Gujarat (IN)

(21) Appl. No.: 17/788,768

(22) PCT Filed: Dec. 26, 2020
(86) PCT No.: PCT/IN2020/051058

§ 371 Date: Jun. 24, 2022

(30) Foreign Application Priority Data
Dec. 27, 2019 (IN) 201911054150

(51) Int. Cl. B01D 69/12; B01D 67/00; B01D 69/02; B01D 71/56

(52) U.S. Cl. CPC B01D 69/125; B01D 67/0006; B01D 69/02; B01D 71/56; B01D 2323/30; B01D 2323/40; B01D 2325/04; B01D 2325/20

(57) ABSTRACT

The present invention relates to ultrathin polymer nanofilm and its composite membrane, its method of preparation. Composite membranes are produced via interfacial polymerization of diamine (or polyamine) monomer (or polymer) and trimesoyl chloride. After IP, post-treatment of washing nascent nanofilm with sufficient volume of solvent and drying at room temperature for 10-30 s followed by annealing at 70-100° C. for 1-10 min is developed. This washing step removes remaining TMC in organic phase and stops further growth of polyamide nanofilm. Ultrathin nanofilm composite membrane gives high water permeance (up to 61.3 Lm⁻²h⁻¹bar⁻¹) with high rejection of Na₂SO₄ (up to 99.3%) by maintaining relatively low rejection of MgCl₂ (up to 27.7%) and NaCl (up to 11.9%) tested under 5 bar pressure at 25 (±1) ° C. with 2 g/L feed solution.

### FIELD OF THE INVENTION

The present invention relates to a highly permeable ultrathin polymer nanofilm composite membrane. Particularly, present invention relates to a process for the preparation of the ultrathin polymer nanofilm composite membrane.

### BACKGROUND OF THE INVENTION

Ultrathin polymer nanofilm and its composite membrane is used for higher liquid permeance as well as to achieve higher rejection of small solutes including divalent and multivalent ions.

Nanofiltration membranes are available with molecular weight cutoff of 250 to 1000 g/mol. They are used for the removal of multivalent ions, small organic molecules, bacteria and viruses. They are also used in waste water treatment, chemical product purification, food production, chlorate and chloroalkaline industry, and in the pre-treatment stages of reverse osmosis based water treatment plants.

Many applications of the nanofiltration membranes are decisive to the permeance of the membrane so that a desired volume can be processed within a reasonable timeframe and this will be well appreciated by those skilled in the art.

Sulfate ion is a common impurity in commercial salt produced from seawater and the separation process of sulfate salts from NaCl is complex.

Ion selective thin film composite membranes have been studied for over three decades and the state-of-art nanofiltration membranes are made from semi-aromatic polyamide, where the membrane is capable of separating sulfate salts from NaCl and the selectivity of the membrane towards Na₂SO₄ to NaCl is around 100.

Highly selective nanofiltration membranes are used for enhanced brine recovery and sulfate removal in chlorate and chloroalkaline industry.

In brine electrolysis processing plants, sodium chloride (ca. 300-350 g/L NaCl) is used as raw material to produce chlorine, sodium hydroxide and hydrogen. The purity of NaCl brine is detrimental to the product quality and up to ca. 20 g/L sulfate salt impurity is the limit to avoid operational problems.

A highly selective separation process is necessary for efficient removal of sulfate salts from NaCl and for the recovery of useful brine from brine streams.

Composite nanofiltration membranes can be used for the partial or complete removal of the amount of undesirable compounds in aqueous solutions. It also relates to the significant removal of sulfate, phosphate, chromium, calcium, mercury, lead, cadmium, magnesium, aluminium and fluoride ions from brine solution.

State-of-the-art of the thin film composite membranes applied for nanofiltration applications are prepared from ca. 2 w/w % of piperazine (PIP) and ca. 0.15 w/w % of trimesoyl chloride (TMC). The quest of fabricating high permeance nanofiltration membrane is a current research trend. Many recent results have reported the process of making high permeance nanofiltration membrane with different fabrication method and adopting different post-treatment protocol.

Reference may be made to an article Nat. Commun. 9, 2018, 2004 by Zhenyi Wang et al. wherein they reported the formation of polyamide film on the polydopamine (PD) decorated zirconium imidazole framework (ZIF) nanoparticles, which shows high water permeance of up to 53.5 Lm⁻²h⁻¹bar⁻¹ with a rejection of 95% of Na₂SO₄.

Reference may be made to an article Science 360, 2018, 518-521 by Tan et al. wherein they reported piperazine based polyamide membranes with controlled Turing structures by adding polyvinyl alcohol (PVA) in aqueous phase via interfacial polymerization with TMC.

These membranes gave high water permeability and high water-salt separation.

Reference may be made to an article J. Mater. Chem. A 6, 2018, 15701-15709 by Junyong Zhu et al. wherein they reported the synthesis of polypiperazine amide free-standing films which exhibited a high water permeance (25.1 Lm⁻²h⁻¹bar⁻¹) and an excellent divalent ion rejection where the rejection of Na₂SO₄ was 99.1%.

Reference may be made to an article Reactive & Functional Polymers 86, 2015, 168-183 by Dihua Wu et al. wherein they reported fabrication of thin film composite nanofiltration membranes using polymeric amine PEI and monomeric amine PIP in combination with TMC.

They showed that 2-ply polyamide membranes fabricated by two cycles of PEI-TMC and PIP-TMC separately formed via interfacial reaction produced a higher rejection of MgCl₂ (98.0%).

Reference may be made to an article J. Membr. Sci. 486, 2015, 169-176 by Chang Liu et al. wherein they reported the fabrication method of layer-by-layer (LBL) assembly of polyelectrolyte crosslinked with glutaraldehyde to developed a novel hollow fiber nanofiltration membrane for low-pressure water softening. This hollow fiber membrane shows good water permeability (˜9.6 Lm⁻²h⁻¹bar⁻¹) with good rejection of MgCl₂ (98.1%).

Reference may be made to an article J. Membr. Sci. 472, 2014, 141-153 by Dihua Wu et al. wherein they reported the fabrication process of thin film composite nanofiltration membrane via interfacial polymerization of PEI and TMC on a microporous polyethersulfone (PES) substrate. The membrane was prepared with a LBL structure by repeated cycles of sequential reactant deposition and reaction. The developed membrane showed better salt rejection of MgCl₂ (up to 97.0%) but with a significant loss in water permeance (ca. 0.2 Lm⁻²h⁻¹bar⁻¹).

Reference may be made to an article J. Membr. Sci. 535, 2017, 357-364 by J. R. Werber et al. wherein they reported a post-treatment method to increase water permeance, water-solute selectivity and surface charge of the polyamide selective layer by quenching of the residual acyl-chloride group of nascent polyamide films. The process decreased the carboxyl group density of polyamide TFC membrane when amine, ammonia, and alcohol solutions including common alcohol solvents such as methanol and ethanol was used as quenching agents. Quenched membrane produced a better water permeance and selectivity. When water was used as a first quenching liquid, the water permeance of the membrane increased 7-8% over the control sample, compared with 85-97% increase of water permeance for membrane quenched with other quenching liquid prior to contact with water.

Reference may be made to an article Desalination 428, 2018, 218-226 by C. Y. Chong et al. wherein they reported a heat treatment process and a post-IP rinsing method to increase pure water permeance in fully aromatic polyamide based reverse osmosis (RO) membrane. The membrane with only polyamide layer being heat-treated exhibited more than 250% enhanced pure water permeance compared to the membrane where both polyamide and substrate layer was heat-treated. The membrane rinsed with pure n-hexane showed ca. 19% higher water permeance without significant decrease in solute rejection when tested for RO desalination.

Reference may be made to U.S. Pat. No. 5,876,602, which discloses a post-treatment method of composite polyamide reverse osmosis membranes, by treating with an aqueous chlorinating agent at a concentration of 200 to 10000 ppm to improve water permeance, lower salt passage and to increase the stability to base.

Reference may be made to U.S. Pat. No. 4,960,517 which describes a method of treating a composite cross-linked polyamide RO membrane to enhance rejection of certain organic compound and sulfuric acid by an amine reactive reagent which react by substitution on the amine such as acetic anhydride and 1,3-propane sultone.

Reference may be made to U.S. Pat. No. 9,452,391B1 which describes a post treatment method by treating the thin film polyamide layer to dihyroxyaryl compounds and nitrous acid to improve water permeance, NaCl rejection and boron rejection.

Reference may be made to U.S. Pat. No. 7,815,987B2 which discloses a method of making polyamide membrane by including a coating comprising a combination of a polyalkylene oxide compound such as poly(ethylene oxide) diglycidyl ether (PEGDE) and polyglycerin-polygliceridylether etc. and a polyacrylamide compound such as polyacrylamide (Mw=10,000) and poly(acrylamide-co-acrylic acid)/80% polyacrylamide (Mw=520,000) etc. There are several methods to improve the water permeance of a membrane by treating the membrane after formation of the polyamide layer.

Reference may be made to U.S. Pat. No. 4,888,116 which describes a method of treating thin film composite RO membrane having a polyamide layer with an aqueous solution of a reagent that reacts with primary amine groups to form diazonium salt groups or derivatives of diazonium salt groups, which can increase the water flux of the polyamide membrane with purportedly little or no effect on the salt rejection of the membrane.

Reference may be made to U.S. Pat. No. 3,551,331 which describes a treatment method for modifying the permeance of a polyamide membrane by treating with a protonic acid, lyotropic salt or a Lewis acid. Water permeability of the treated polyamide membrane was increased when the concentration of treating agent was increased and also the treatment temperature was higher.

Reference may be made to U.S. Pat. No. 3,904,519 which discloses a process of treatment of linear aromatic polyamide with crosslinking reagents to improve permeance or permeance stability of the resulting membrane.

Reference may be made to U.S. Pat. No. 4,277,344 which discloses the post-treatment method of a polyamide membrane with a solution containing 100 ppm hypochlorite for one day to improve performance of the membrane. The effect of chlorine treatment was a reduction in water permeance in most of the cases however an improved salt rejection was observed.

Reference may be made to U.S. Pat. No. 4,761,234 which discloses a treatment method to improve the performance of a polyamide thin film composite membrane that includes a triamino-benzene as one monomer with an aqueous solution containing 1000 ppm residual chlorine at a pH of 10.3 at room temperature for 18 hours.

Reference may be made to U.S. Pat. No. 4,812,270 by Cadotte et al. which describes a post-treatment of the membrane with phosphoric acid which demonstrated an increased salt rejection and water permeance of the membrane where the increased permeance was as high as 50%.

Reference may be made to U.S. Pat. No. 5,582,725 which describes a post treatment method with an acyl halide such as benzoyl chloride to improve organic rejection like benzaldehyde, ethanol, 2-butoxyethanol, cresol, urea and phenol etc. by compromising water flux after treatment.

### OBJECTS OF THE INVENTION

The main object of the present invention is to provide an ultrathin polymer nanofilm composite membrane and method for preparation thereof.

Another object of the present invention is to control the thickness of the polymer nanofilm made via interfacial polymerization.

Yet another object of the present invention is to provide process of the preparation of ultrathin polymer nanofilm by a post-treatment process of washing the nanofilm soon after the interfacial polymerization reaction.

Yet another object of the present invention is to provide the process of isolating the ultrathin polymer nanofilm separation layer of a composite membrane.

Yet another object of the present invention is to provide the process of isolating the nanofilm separation layer of a composite membrane and to transfer the free-standing nanofilm layer onto different substrate while keeping the top surface of the nanofilm facing upward.

Yet another object of the present invention is to provide process of the preparation of ultrathin polyamide nanofilm by reacting piperazine (PIP) with trimesoyl chloride (TMC) via interfacial polymerization.

Yet another object of the present invention is to provide process of the preparation of ultrathin polymer nanofilm composite membrane with high water permeance.

Yet another object of the present invention is to provide process of the preparation of ultrathin polymer nanofilm composite membrane with high rejection of sulfate salts.

Yet another object of the present invention is to provide process of the preparation of ultrathin polymer nanofilm composite membrane with high ion selectivity.

Yet another object of the present invention is to provide process of the preparation of ultrathin polymer nanofilm composite membrane with high rejection of ions from mixed salt water.

Yet another object of the present invention is to provide ultrathin polymer nanofilm composite membranes which selectively separate ions from sea water.

Yet another object of the present invention is to control the chemical structure of the polymer nanofilm to make selective separation membrane between monovalent to divalent ions.

Yet another object of the present invention is to control the chemical structure of the polymer nanofilm by a post-treatment process of washing the nanofilm soon after interfacial polymerization reaction.

### BRIEF DESCRIPTION OF THE DRAWINGS

FIG. 1 represents surface morphology of the nanofilm composite membranes prepared on hydrolyzed Polyacrylonitrile (HPAN) support and observed under scanning electron microscope (SEM). (A, B) 1.0 w/w % PIP reacted with 0.1 w/w % TMC for 5 s. (C, D) 2.0 w/w % PIP reacted with 0.1 w/w % TMC for 5 s. (E, F) 0.1 w/w % PIP reacted with 0.1 w/w % TMC for 5 s. Images on the right panel are under higher magnification.

FIG. 2(A-C) represents Transmission electron microscopy (TEM) images of the freestanding nanofilm captured under different magnifications. Nanofilm was prepared on Polyacrylonitrile (PAN) support from 1 w/w % PIP and 0.1 w/w % TMC reacted for 5 s. A post treatment of washing with hexane was done after the interfacial polymerization to remove excess TMC.

FIG. 3 (A, B) represents Cross-sectional Atomic force microscopy (AFM) height image and corresponding height profile of the freestanding polyamide nanofilm transferred onto a silicon wafer (PIP-0.05%-0.1%-5 s-hex71). Nanofilm was prepared on PAN support from 0.05 w/w % PIP in aqueous phase and 0.1 w/w % TMC in hexane and reacted for 5 s. A post treatment of washing in hexane was done as described above.

FIG. 4 represents Chemical structures of (a) fully crosslinked and (b) fully linear polyamide prepared from the interfacial polymerization of piperazine (PIP) and trimesoyl chloride (TMC). The unit of the repeated pattern is presented in the dotted box of the polymer structure.

### SUMMARY OF THE INVENTION

Accordingly, present invention provides a highly permeable ultrathin polymer nanofilm composite membrane comprising:
i. a base layer of porous polymer support membrane;
ii. an upper polymer nanofilm;
wherein the polymer nanofilm is made via interfacial polymerization and thickness of the polymer nanofilm is in the range of 4 nm to 50 nm.

In an embodiment of the present invention, the base layer of porous polymer support membrane is selected from the group consisting of hydrolyzed Polyacrylonitrile (HPAN), polysulfone (PSF), polyethersulfone (PES), P84 and polyacrylonitrile (PAN).

In yet another embodiment of the present invention, the membrane exhibits Na₂SO₄ rejections in the range of 81% to 99.82% with high value of pure water permeance in the range of 30 LMHbar-1 to 79.5 LMHbar⁻¹.

In yet another embodiment of the present invention, the membrane exhibits pure water permeance in the range of 23.2 LMHbar⁻¹ to 79.5 LMHbar⁻¹ with a rejection of MgCl₂ and NaCl in the range of 4% to 98.5% and 3% to 36.6% respectively.

In yet another embodiment of the present invention, the nanofilm has an elemental composition of: 76.86% carbon, 13.40% oxygen and 9.74% nitrogen and 52.5% of a degree of network crosslinking; or: 74.54% carbon, 13.11% oxygen, and 12.33% nitrogen and 90.8% of a degree of network crosslinking in case of the polymer repeating unit selected from piperazine and trimesoyl chloride.

In yet another embodiment, present invention provides a process for the preparation of the highly permeable ultrathin polymer nanofilm composite membrane comprising the steps of:
i. preparing a polymer support membrane via phase inversion method on a nonwoven fabric;
ii. modifying the polymer support membrane as obtained in step (i) to obtain a hydrophilic support;
iii. pouring aqueous solution containing a diamine or polyamine with a concentration in the range of 0.01 to 5.0 w/w % on top of the polymer support membrane as obtained in step (i) or (ii) followed by soaking for 10 seconds to 1 minute;
iv. discarding the aqueous solution from the polymer support membrane and removing the remaining aqueous solution with a rubber roller followed by air drying for 10 seconds to 1 minute;
v. immediately contacting organic solution containing polyfunctional acid halide with a concentration in the range of 0.01 to 0.5 w/w % with the polymer support membrane of step (iv) for a period in the range of 5 seconds to 5 min for interfacial polymerization;
vi. removing excess organic solution followed by removing unreacted polyfunctional acid halide remained on the nanofilm by washing with a solvent and drying the membrane at room temperature for 10 to 30 seconds;
vii. annealing the membrane at a temperature in the range of 40 to 90° C. for a period in the range of 1 to 10 min to obtain the highly permeable ultrathin polymer nanofilm composite membrane.

In yet another embodiment of the present invention, in step (iii), the diamine or polyamine is selected from the group consisting of piperazine (PIP), m-phenylenediamine (MPD), p-phenylenediamine (PPD), polyethyleneimine (PEI), 4-(Aminomethyl)piperidine (AMP), 1,3-cyclohexane diamine (CDA13), 1,4-cyclohexane diamine (CDA14), 1,6-hexanediamine (HDA), ethylene diamine (EDA), resorcinol (RES), phloroglucinol (PHL), pentaerythritol (PET), quercetin (QCT), bisphenol A (BPA), and melamine (MM) alone or in combination thereof.

In yet another embodiment of the present invention, in step (v) the polyfunctional acid halide used is trimesoyl chloride (TMC) or terephthaloyl chloride (TPC).

In yet another embodiment of the present invention, in step (vi), the solvent used is selected from the group consisting of hexane, toluene, xylene, acetone, methanol, ethanol, propanol, isopropanol, water, dimethylformamide (DMF), dimethylacetamide (DMAc), N-methylpyrrolidone (NMP), acetonitrile either alone or combination thereof.

In yet another embodiment of the present invention, the organic polymeric nanofilm is prepared by interfacial polymerization at the interface of two immiscible liquids.

### DETAILED DESCRIPTION OF THE INVENTION

Present invention relates to an ultrathin polymer nanofilm and its composite membrane and its preparation via interfacial polymerization (IP) of two reactive molecules dissolved in two immiscible solvents and contacting them at the interface made on a porous support.

Interfacial polymerization is a technique where one reactive molecule is used in the aqueous (polar) phase and another reactive molecule is used in the organic (nonpolar) phase on the porous support (e.g. ultrafiltration, microfiltration) to fabricate thin films composite (TFC) membrane. Typically, a porous support membrane is saturated with an aqueous solution of diamine (or polyamine) and contacted with a hexane layer containing TMC, enables the synthesis of polymer nanofilms via interfacial polymerization.

Present invention discloses a process for the preparation of isolated free-standing nanofilm via controlled dissolution of the support membrane where the nanofilm was produced via interfacial polymerization. Present invention further discloses a process for the preparation of composite membrane, wherein after the formation of the nanofilm via interfacial polymerization, a post-treatment of washing the nanofilm with a sufficient volume of solvent and drying at room temperature [20 to 30° C.] for 10-30 s followed by annealing at 70-100° C. for 1-10 min was adopted.

Interfacial polymerization was done on top of an ultrafiltration support by choosing a combination of diamine (or polyamine) in the aqueous phase with concentration of 0.01 to 3.0 w/w % and TMC in the hexane phase with concentration of 0.01 to 0.5 w/w %. Several diamine (or polyamine) monomer (or polymer) such as piperazine (PIP), m-phenylenediamine (MPD), polyethyleneimine (PEI), 4-(Aminomethyl)piperidine (AMP) are employed to react with TMC and to form ultrathin polyamide nanofilm on the support. A post-treatment protocol of washing of the nascent polymer nanofilm fabricated on the support with solvent is adopted where the washing solvent is chosen from hexane, toluene, xylene, acetone, methanol, ethanol, propanol, isopropanol, water, dimethylformamide (DMF), dimethylacetamide (DMAc), N-methylpyrrolidone (NMP) and acetonitrile or a mixture of the said solvents or a combination of them. This washing step removes the residual TMC in the organic phase and stops further growth of the polyamide nanofilm layer formed after the interfacial polymerization reaction during drying and annealing. The washing step assists to stop the polymerization reaction and hence to reduce the effective thickness of the polymer nanofilm compared to the conventional polyamide film formed via interfacial polymerization.

Novelty of the invention is to tune the salt rejection property of the nanofilm composite membrane by choosing a combination of concentration of diamine (or polyamine) monomer (or polymer) and TMC and to achieve superior membrane separation performance. At very low concentration of PIP (0.05 w/w %), the fabricated ultrathin polymer nanofilm composite membrane gives high water permeance (up to 70.8 Lm⁻²h⁻¹bar¹) with high rejection of Na₂SO₄ (up to 96.5%) by maintaining low rejection of MgCl₂ (up to 16.4%) and NaCl (up to 9.0%) tested under 5 bar applied pressure at 25 (±1) ° C. temperature with a 2 g/L feed solution. At moderately low concentration of PIP (0.1 w/w %), the fabricated ultrathin polymer nanofilm composite membrane gives high water permeance (up to 61.3 Lm⁻²h⁻¹bar¹) with high rejection of Na₂SO₄ (up to 99.3%) by maintaining low rejection of MgCl₂ (up to 27.7%) and NaCl (up to 11.9%) tested under 5 bar applied pressure at 25 (±1) ° C. temperature with a 2 g/L feed solution. Another novelty of the invention is that at high concentration (1.0 to 2.0 w/w %) of PIP the fabricated ultrathin polymer nanofilm composite membrane gives a water permeance in the range of 37.1-38.4 Lm⁻²h⁻¹bar¹ with high rejection of Na₂SO₄ (up to 99.82%) and MgCl₂ (93.5-98.5%) by maintaining low NaCl rejection (up to 19.1-28.3%) when tested under 5 bar applied pressure at 25 (±1) ° C. temperature with a 2 g/L feed solution.

### EXAMPLES

Following examples are given by way of illustration and therefore should not be construed to limit the scope of the invention.

### Example 1

### Preparation of Ultrafiltration Support Membranes and Crosslinking of Support Membranes

Ultrafiltration polysulfone (PSf), polyethersulfone (PES), P84 and polyacrylonitrile (PAN) support membranes were prepared via phase inversion method. Polyacrylonitrile (PAN) support membrane was prepared on a nonwoven fabric by using a continuous casting machine. First PAN polymer powder was dried in a hot air oven at 70 (±1) ° C. for two hours and then dried PAN was dissolved in DMF by continuous stirring at 70 (±1) ° C. for several hours in an airtight glass flask to make a 13.0 w/w % polymer solution. Polymer solution was then allowed to cool down to room temperature 25 (±1) ° C. Membrane sheet of ca. 60 m length and 0.32 m wide was continuously cast on a nonwoven fabric by maintaining a gap (130-150 μm) between the casting knife and the nonwoven fabric at a speed of 5 m/min using a semi-continuous casting machine. During this process, polymer film along with the nonwoven fabric is taken into water gelation bath maintained at 25 (±1) ° C. and allowed phase inversion to form ultrafiltration membrane and taken in a winder roller. The distance between the knife position and the water gelation bath i.e. the distance traveled in air was ca. 0.35 m. Membrane roll was then washed with pure water and cut into pieces of dimension 16 cm×27 cm and kept in pure water for two days prior to the final storage at 10 (±1) ° C. in isopropanol and water mixture (1:1 v/v). For crosslinking of ultrafiltration supports, several pieces (ca. 75 nos.) of PAN supports were taken out from the storage solution and washed thoroughly in pure water. Supports were then immersed in a 5 L of 1 M sodium hydroxide (NaOH) solution preheated at 60° C. and the solution was placed in a hot air oven at 60 (±1) ° C. for two hours to allow hydrolysis. After crosslinking, PAN membranes were washed with pure water and stored in pure water for several days. The pH of water was regularly checked and exchanged with pure water every day until the pH was reached to ca. 7. Finally, the hydrolyzed PAN (HPAN) membrane pieces were stored at 10 (±1) ° C. in isopropanol and water mixture (1:1 v/v). Similarly, PSf polymer solution was prepared by dissolving 17 w/w % of PSf in NMP, P84 polymer solution was prepared by dissolving 22 w/w % of P84 in DMF and PES polymer solution was prepared by dissolving 19 w/w % of PES along with 3 w/w % of PVP in DMF. Support membranes were fabricated via phase inversion method as discussed above.

### Example 2

### Preparation of Nanofilm Composite Membranes

Nanofilm composite membranes were prepared via conventional interfacial polymerization technique on the top of HPAN, PAN, PSf, PES, P84 support membrane. Support was washed with ultrapure water to remove excess isopropanol, where the membrane was stored. Then the aqueous solution containing a diamine (or polyamine) chosen from PIP, MPD, AMP, PEI with a concentration in the range of 0.01 to 5.0 w/w % was poured on top of the support and soaked for ca. 20 s. After that excess aqueous solution was removed from the support with a rubber roller and gently air dried for ca. 10 s. Immediately hexane solution containing TMC with a concentration in the range of 0.01 to 0.5 w/w % was put in contact of the support for a designated time (5 s to 5 min) to happen the interfacial polymerization reaction. Excess hexane solution containing TMC was removed soon after the interfacial polymerization reaction and the unreacted TMC remained on the nanofilm surface was further removed by washing with pure hexane and dried at room temperature for 10-30 s. The composite membrane was finally annealed at a specified temperature of 40-90° C. for a specified time of 1-10 min in a hot air oven. Unless otherwise stated, the diamine monomers (amine polymers) were taken in aqueous solution and TMC was taken in hexane solution for the interfacial polymerization and after washing the nanofilm with solvent the drying time at room temperature was for 30 s. Preparation conditions of the nanofilm composite membrane are summarized below:

TABLE 1
Preparation conditions of the nanofilm composite membrane via interfacial polymerization (IP)

| | | | | | |
|---|---|---|---|---|---|
| Polymer nanofilm | | | | | |
| (amine w/w %-TMC | Aqueous | TMC in | | Washing step | |
| w/w %-IP time-washing | phase of | hexane | | (includes solvent | |
| solvent-annealing | amine | phase | | wash/subsequent | Annealing |
| temperature & time) | [w/w %] | [w/w %] | IP time | solvent wash) | condition |

Fabricated on HPAN support

| | | | | | | |
|---|---|---|---|---|---|---|
| PIP-0.05%-0.1%-5 s- | PIP [0.05] | TMC [0.1] | 5 | s | Washed in hexane | 70° C./1 min |
| hex71 | | | | | | |
| PIP-0.05%-0.1%-60 s- | PIP [0.05] | TMC [0.1] | 60 | s | Washed in hexane | 70° C./1 min |
| hex71 | | | | | | |
| PIP-0.05%-0.15%-5 s- | PIP [0.05] | TMC [0.15] | 5 | s | Washed in hexane | 70° C./1 min |
| hex71 | | | | | | |
| PIP-0.05%-0.15%-60 s- | PIP [0.05] | TMC [0.15] | 60 | s | Washed in hexane | 70° C./1 min |
| hex71 | | | | | | |
| PIP-0.1%-0.1%-5 s- | PIP [0.1] | TMC [0.1] | 5 | s | Washed in hexane | 70° C./1 min |
| hex71 | | | | | | |
| PIP-0.1%-0.15%-5 s- | PIP [0.1] | TMC [0.15] | 5 | s | Washed in hexane | 70° C./1 min |
| hex71 | | | | | | |
| PIP-0.1%-0.15%-60 s- | PIP [0.1] | TMC [0.15] | 60 | s | Washed in hexane | 70° C./1 min |
| hex71 | | | | | | |
| PIP-1.0%-0.1%-5 s- | PIP [1.0] | TMC [0.1] | 5 | s | Washed in hexane | 70° C./1 min |
| hex71 | | | | | | |
| PIP-1.0%-0.15%-5 s- | PIP [1.0] | TMC [0.15] | 5 | s | Washed in hexane | 70° C./1 min |
| hex71 | | | | | | |
| PIP-1.0%-0.15%-60 s- | PIP [1.0] | TMC [0.15] | 60 | s | Washed in hexane | 70° C./1 min |
| hex71 | | | | | | |
| PIP-2.0%-0.05%-5 s- | PIP [2.0] | TMC [0.05] | 5 | s | Washed in hexane | 70° C./1 min |
| hex71 | | | | | | |
| PIP-2.0%-0.1%-5 s- | PIP [2.0] | TMC [0.1] | 5 | s | Washed in hexane | 70° C./1 min |
| hex71 | | | | | | |
| PIP-2.0%-0.15%-5 s- | PIP [2.0] | TMC [0.15] | 5 | s | Washed in hexane | 70° C./1 min |
| hex71 | | | | | | |
| PIP-0.1%-0.1%-5 s- | PIP [0.1] | TMC [0.1] | 5 | s | Washed in hexane | 40° C./5 min |
| hex45 | | | | | | |
| PIP-0.1%-0.1%-5 s- | PIP [0.1] | TMC [0.1] | 5 | s | Washed in hexane | 70° C./5 min |
| hex75 | | | | | | |
| PIP-0.1%-0.1%-5 s- | PIP [0.1] | TMC [0.1] | 5 | s | Washed in hexane | 70° C./10 min |
| hex710 | | | | | | |
| PIP-0.1%-0.1%-30 s- | PIP [0.1] | TMC [0.1] | 30 | s | Washed in hexane | 70° C./1 min |
| hex71 | | | | | | |
| PIP-0.1%-0.1%-1 m- | PIP [0.1] | TMC [0.1] | 1 | min | Washed in hexane | 70° C./1 min |
| hex71 | | | | | | |
| PIP-0.1%-0.1%-5 m- | PIP [0.1] | TMC [0.1] | 5 | min | Washed in hexane | 70° C./1 min |
| hex71 | | | | | | |
| PIP-0.1%-0.1%-5 m- | PIP [0.1] | TMC [0.1] | 5 | min | Washed in hexane | 70° C./5 min |
| hex75 | | | | | | |
| PIP-0.1%-0.1%-5 s- | PIP [0.1] | TMC [0.1] | 5 | s | Washed in hexane | 80° C./1 min |
| hex81 | | | | | | |
| PIP-0.1%-0.1%-5 s- | PIP [0.1] | TMC [0.1] | 5 | s | Washed in hexane | 90° C./1 min |
| hex91 | | | | | | |
| PIP-0.1%-0.1%-5 s- | PIP [0.1] | TMC [0.1] | 5 | s | Washed in toluene | 70° C./1 min |
| tol71 | | | | | | |
| PIP-0.1%-0.1%-5 s- | PIP [0.1] | TMC [0.1] | 5 | s | Washed in xylene | 70° C./1 min |
| xyl71 | | | | | | |
| PIP-0.1%-0.1%-5 s- | PIP [0.1] | TMC [0.1] | 5 | s | Washed in acetone | 70° C./1 min |
| ace71 | | | | | | |
| PIP-0.1%-0.1%-5 s- | PIP [0.1] | TMC [0.1] | 5 | s | Washed in methanol | 70° C./1 min |
| meoh71 | | | | | | |
| PIP-0.1%-0.1%-5 s- | PIP [0.1] | TMC [0.1] | 5 | s | Washed in ethanol | 70° C./1 min |
| etoh71 | | | | | | |
| PIP-0.1%-0.1%-5 s- | PIP [0.1] | TMC [0.1] | 5 | s | Washed in | 70° C./1 min |
| acn71 | | | | | acetonitrile | |
| PIP-0.1%-0.1%-5 s- | PIP [0.1] | TMC [0.1] | 5 | s | Washed in propanol | 70° C./1 min |
| prop71 | | | | | | |
| PIP-0.1%-0.1%-5 s- | PIP [0.1] | TMC [0.1] | 5 | s | Washed in 2- | 70° C./1 min |
| ipa71 | | | | | propanol | |
| PIP-0.1%-0.1%-5 s- | PIP [0.1] | TMC [0.1] | 5 | s | Washed in water | 70° C./1 min |
| water71 | | | | | | |
| PIP-0.1%-0.1%-5 s- | PIP [0.1] | TMC [0.1] | 5 | s | Washed in hexane | 70° C./1 min |
| hex-water71 | | | | | and then water | |
| PIP-0.1%-0.1%-5 s- | PIP [0.1] | TMC [0.1] | 5 | s | Washed in methanol | 70° C./1 min |
| meoh-water71 | | | | | and then water | |
| PIP-0.1%-0.1%-5 s- | PIP [0.1] | TMC [0.1] | 5 | s | Washed in hexane | 70° C./1 min |
| hex-meoh71 | | | | | and then methanol | |
| MPD-1.0%-0.15%-5 s- | MPD [1.0] | TMC [0.15] | 5 | s | Washed in hexane | 70° C./1 min |
| hex71 | | | | | | |
| MPD-1.0%-0.15%-1 m- | MPD [1.0] | TMC [0.15] | 1 | min | Washed in hexane | 70° C./1 min |
| hex71 | | | | | | |
| PEI-1.0%-0.15%-1 m- | PEI [1.0] | TMC [0.15] | 1 | min | Washed in hexane | 70° C./1 min |
| hex71 | | | | | | |
| AMP-1.0%-0.15%-1 m- | AMP [1.0] | TMC [0.15] | 1 | min | Washed in hexane | 70° C./1 min |
| hex71 | | | | | | |

Fabricated on PAN support

| | | | | | | |
|---|---|---|---|---|---|---|
| PIP-0.1%-0.1%-5 s- | PIP [0.1] | TMC [0.1] | 5 | s | Washed in hexane | 70° C./1 min |
| hex71 | | | | | | |

Fabricated on PSf support

| | | | | | | |
|---|---|---|---|---|---|---|
| PIP-0.1%-0.1%-5 s- | PIP [0.1] | TMC [0.1] | 5 | s | Washed in hexane | 70° C./1 min |
| hex71 | | | | | | |

Fabricated on PES support

| | | | | | | |
|---|---|---|---|---|---|---|
| PIP-0.1%-0.1%-5 s- | PIP [0.1] | TMC [0.1] | 5 | s | Washed in hexane | 70° C./1 min |
| hex71 | | | | | | |

Fabricated on P84 support

| | | | | | | |
|---|---|---|---|---|---|---|
| PIP-0.1%-0.1%-5 s- | PIP [0.1] | TMC [0.1] | 5 | s | Washed in hexane | 70° C./1 min |
| hex71 | | | | | | |

### Example 3

### Process of Isolating the Separation Layer of a Composite Membrane and Making Freestanding Nanofilm:

We used a nanofilm composite membrane made via interfacial polymerization of PIP and TMC on PAN support, a thin film composite membrane prepared on conventional support prepared via interfacial polymerization of MPD and TMC on PAN support, and a commercial TFC reverse osmosis membrane). The composite membrane was allowed to swell in acetone by dipping in acetone for 30 min. The support membrane along with the nanofilm was peeled-off from the nonwoven fabric with the help of an adhesive tape. The adhesive tape was adhered on the top of the composite membrane i.e. on the surface of the nanofilm and nonwoven fabric was peeled-off by detaching the support (along with the nanofilm) from the fabric. Acetone was added during this process to help separating the layers. The nanofilm along with the support was then cut to make a small piece and floated on the surface of DMF containing 2 v/v % of water and waited for overnight. During this time water contained DMF solution slowly dissolved the polymer support leaving only the nanofilm layer floating on the solution surface. Nanofilm was then transferred on different supports, such as anodic alumina, silicon, copper grid, where the rear side (facing aqueous phase during interfacial polymerization) of the nanofilm resided on the support and the top surface (facing organic phase during interfacial polymerization) remained on the top. Finally, the support containing nanofilm was dried at room temperature, washed in methanol and finally dried in a hot air oven at a temperature of 50° C. for 30 min and used for characterization.

### Example 4

### Analysis of Surface Morphology and Estimation of Thickness of the Nanofilms by Scanning Electron Microscopy (SEM):

Scanning electron microscopy (SEM) was used to analyze the surface morphology and the cross-sectional image of the membrane. Sample surface was coated with a 2-3 nm thick gold-palladium coating prior to the SEM study. To avoid error in the thickness estimation, because of surface coating, ca. 20 nm or above measured values were considered.

### Example 5

### Study the Surface Morphology and Estimation of Thickness of the Nanofilms by Atomic Force Microscopy (AFM)

The surface morphology such as roughness and thickness of the nanofilm was measured by NT-MDT, NTEGRA Aura Atomic Force Microscopy (AFM) with a pizzo-type scanner.

Some of the samples were also characterized with Bruker Dimension 3100 and the images were captured under tapping mode using PointProbe® Plus silicon-SPM probes (PPP-NCH, Nanosensors™, Switzerland). For the measurement of thickness, the nanofilm was transferred onto a silicon wafer and a scratch was made to expose the wafer surface and allow measurement of the height from the silicon wafer surface to the upper nanofilm surface. The step height was an estimation of the thickness of the nanofilm. A sampling resolution of 256 or 512 points per line and a speed of 0.5 to 1.0 Hz were used. Gwyddion 2.52 SPM data visualization and analysis software was used for image processing.

### Example 6

### Surface Morphology of the Nanofilm Composite Membranes Observed Under SEM

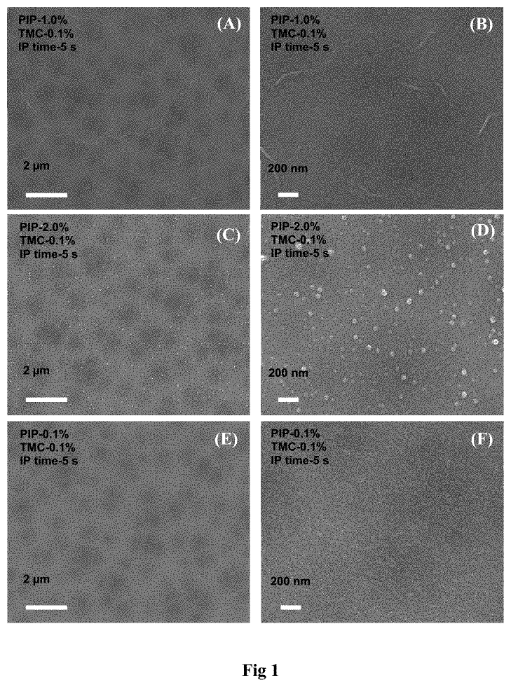

SEM was used to analyze the surface morphology of the membranes and are presented in FIG. 1. The nanofilm membranes were prepared with PIP and TMC via interfacial polymerization on HPAN support. Excess hexane solution containing TMC was removed soon after the reaction and the unreacted TMC remained on the nanofilm surface was further removed by washing with pure hexane and dried at room temperature for 30 s. The composite membranes were finally annealed at 70° C. for 1 min in a hot air oven. SEM images are captured on the nanofilm composite membrane without removing the support.

### Example 7

### Surface Morphology of the Nanofilm Composite Membranes Observed Under TEM

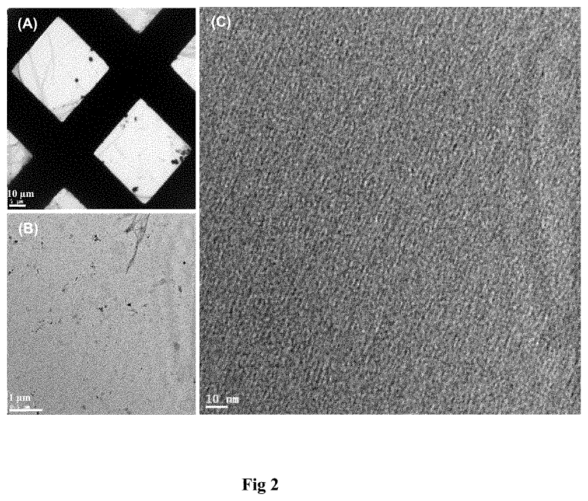

The nanofilm was prepared via interfacial polymerization from 1 w/w % PIP and 0.1 w/w % TMC reacted for 5 s on PAN support. Excess hexane solution containing TMC was removed soon after the reaction and the unreacted TMC remained on the nanofilm surface was further removed by washing with pure hexane and dried at room temperature for 30 s. The composite membranes were finally annealed at 70° C. for 1 min in a hot air oven. Nanofilm along with the support was then peeled-off from the fabric and made freestanding as described above. Freestanding nanofilm was then transferred onto a copper mess of a TEM grid and dried at 50° C. for 15 min in a hot air oven to study under TEM. Images are presented in FIG. 2. A defect-free nanofilm which is amorphous in nature and covering the entire surface of the TEM grid is observed.

### Example 8

Thickness Estimation of the Nanofilms from the Cross-Sectional AFM Images

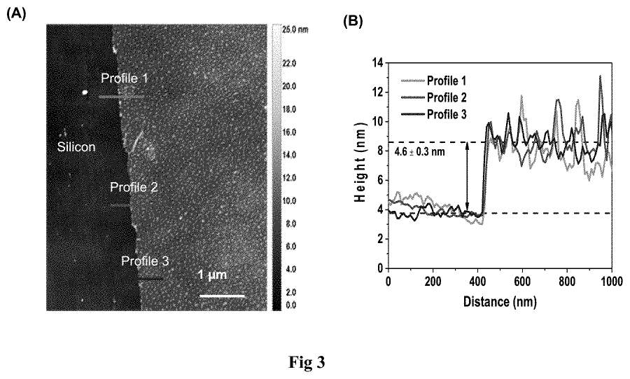

Cross-sectional AFM images were captured to measure the thickness of the nanofilm. Images are presented in FIG. 3. Nanofilm was prepared from 0.05 w/w % PIP in aqueous phase and 0.1 w/w % TMC in hexane and reacted for 5 s on PAN support. Excess hexane solution containing TMC was removed soon after the reaction and the unreacted TMC remained on the nanofilm surface was further removed by washing with pure hexane and dried at room temperature for 30 s. The composite membranes were finally annealed at 70° C. for 1 min in a hot air oven. A freestanding nanofilm was transferred onto a silicon wafer as described above. The support containing nanofilm was then dried at room temperature, washed in methanol and finally dried in a hot air oven at a temperature of 50° C. for 30 min and used for characterization. For the thickness measurement, a scratch was made to expose the wafer surface and allow measurement of the height from the silicon wafer surface to the upper nanofilm surface.

### Example 9

### Determination of Surface Charge by Zeta Potential Measurements

The surface charge of the nanofilm membrane was determined by the zeta potential measurement. Zeta potential value was obtained by ZetaCad zeta potential analyzer. Membranes were cut into 5 cm×3 cm and placed in the cell. The measurement was carried out at 25° C. with standard electrolyte of 1 mM KCl. Zeta potential of different membranes were measured at pH 7. The measured zeta potential value of the membranes was in the range of −20 to −30 mV.

### Example 10

### Desalination Performance Evaluation of the Nanofilm Composite Membranes

The desalination performance of the nanofilm composite membranes were tested in a cross-flow filtration system with a cross-flow velocity of 50 L/h. Circular membrane samples were used in each testing cell with an effective surface area of 14.5 cm². All experiments were performed under 5 bar applied pressure with 2 g/L salt concentration as feed solution and maintaining the feed temperature at 25 (±1) ° C. All results were collected after allowing the membrane to reach at the steady state. This was achieved by waiting for ca. 7 hours under cross-flow at 5 bar pressure, where the permeance of the membrane was almost constant. The permeance of the membrane was calculated by the following equation:

J=V/A·t (i)

where V is the volume of the permeate (liter), A is the surface area of the membrane (m²) and t is the time in hour. The rejection of the membranes was calculated from the conductivity ratio between the difference of feed and permeate concentrations to the feed concentrations.

$$Rejection ( \% ) = \frac{Cf ( feed ) - Cp ( permeate )}{Cf ( feed )} \times 100 \qquad ( ii )$$

where Cₚ is the concentration of dissolved salt in the permeate and C_{f} is the concentration of dissolved salt in the feed side.
Ion (or salt) selectivity was represented by

$$Selectivity = \frac{100 - Concentration of 1 st ion ( or salt )}{100 - Concentration of 2 nd ion ( or salt )} \qquad ( iii )$$

Double pass RO treated water (conductivity <2 μS) was used for the measurement of pure water permeance as well as for making feed solutions. An electrical conductivity meter (Eutech PC2700) was used to measure the conductivity of the samples in the range of a few microSiemens (μS) to a few milliSiemens (mS). The conductivity of the permeate sample, where the measured conductivity was above 10 μS, and the conductivity of the feed sample was measured to calculate the salt rejection using equation (ii). The conductivity of the permeate sample, where the measured conductivity was below 10 μS, the inductively coupled plasma mass spectrometry (ICP-MS) and ion chromatography (IC) was used to measure the ion concentration in the sample. Both feed and permeate samples were analyzed with ICP-MS and IC after necessary dilution. Rejection and selectivity were determined using equation (ii) and (iii) respectively.

### Example 11

Evaluation of Thickness from AFM or SEM

Thickness of the polyamide nanofilm was determined through AFM analysis for a thickness less than ca. 20 nm. A freestanding nanofilm was transferred onto a silicon wafer as described above. The support containing nanofilm was then dried at room temperature, washed in methanol and finally dried in a hot air oven at a temperature of 50° C. for 30 min. For the thickness measurement, a scratch was made to expose the wafer surface and allow measurement of the height from the silicon wafer surface to the upper nanofilm surface. The AFM height images of the polyamide nanofilms were recorded and analyzed.

TABLE 2
Estimated thickness of the nanofilms from AFM. Nanofilm was
made via interfacial polymerization and washed with hexane.

| | Thickness | |
|---|---|---|
| Nanofilms | (nm) | Reference |
| PIP-0.05%-0.1%-5 s-hex71 | 4.6 ± 0.3 | Present Invention |
| PIP-0.1%-0.1%-5 s- hex71 | <8 nm | Present Invention |
| PIP-1.0%-0.1%-5 s- hex71 | <10 nm | Present Invention |
| PIP-2.0%-0.05%-5 s- hex71 | <15 nm | Present Invention |
| PIP-2.0%-0.1%-5 s- hex71 | <13 nm | Present Invention |
| PIP-2.0%-0.15%-5 s- hex71 | <9 nm | Present Invention |
| NCM-0.025%-0.05%. | 12.0 | J. Mater. Chem. A, 6, 2018, 15701 (ref 1) |
| PEI-TMC @ pH 6.5 | 77.4 | J. Membr. Science, 524, 2017, 174 (ref 2) |
| BHTTM/PIP (After oxidation) | 91.0 | J. Membr. Science, 498, 2016, 374 (ref 3) |
| NF3 (PIP/0.09 wt % Sericin-TMC) | 128.0 | J. Membr. Science, 523, 2017, 282(ref 4) |
| PA50/CNC/PES | 145.0 | J. Mater. Chem. A, 5, 2017, 16289 (ref 5) |

### Example 12

### Nanofiltration Performance of the Nanofilms Composite Membranes

Nanofiltration performance of the nanofilms composite membranes fabricated on HPAN support is presented in the Table 3. Individual salt solution (Na₂SO₄, MgSO₄, MgCl₂ and NaCl) as a feed of concentration 2 g/L was used for the experiment.

TABLE 3
Nanofiltration performance of the nanofilm composite membranes fabricated on HPAN
support, wherein the nanofilm is the separation layer of the composite membrane.
Nanofilm was made via interfacial polymerization and washed with hexane.

| Nanofilm | Nanofiltration performance of the membrane | | | | | |
|---|---|---|---|---|---|---|
| composite | | Feed → | | | | |
| membrane and its | | Pure | | | | |
| thickness (nm) | | water | Na₂SO₄ | MgSO₄ | MgCl₂ | NaCl |
| PIP-0.05%-0.1%- | Water permeance | 70.8 ± 3.2 | 33.4 ± 1.2 | 37.0 ± 2.6 | 53.4 ± 2.1 | 55.9 ± 1.0 |
| 5 s-hex71 | (Lm⁻²h⁻¹bar⁻¹) | | | | | |
| Thickness: 4.6 nm | | | | | | |
| | Salt rejection | — | 96.53 ± 2.3 | 84.8 ± 6.5 | 16.4 ± 2.5 | 9.0 ± 2.2 |
| | (%) | | | | | |
| PIP-0.1%-0.1%- | Water permeance | 61.3 ± 2.6 | 32.9 ± 1.8 | 36.3 ± 2.1 | 44.8 ± 2.1 | 50.6 ± 1.6 |
| 5 s-hex71 | (Lm⁻²h⁻¹bar⁻¹) | | | | | |
| Thickness: <8 nm | | | | | | |
| | Salt rejection | — | 99.46 ± 0.1 | 94.8 ± 0.7 | 27.7 ± 0.5 | 11.9 ± 0.8 |
| | (%) | | | | | |
| PIP-1.0%-0.1%- | Water permeance | 37.1 ± 2.0 | 24.6 ± 1.4 | 27.2 ± 1.3 | 23.3 ± 1.4 | 32.5 ± 1.5 |
| 5 s-hex71 | (Lm⁻²h⁻¹bar⁻¹) | | | | | |
| Thickness: <10 nm | | | | | | |
| | Salt rejection | — | 99.76 ± 0.13 | 99.1 ± 0.4 | 93.5 ± 0.94 | 25.1 ± 3.8 |
| | (%) | | | | | |
| PIP-2.0%-0.05%- | Water permeance | 23.2 ± 1.7 | 16.7 ± 1.0 | 18.3 ± 1.2 | 15.2 ± 1.0 | 19.7 ± 1.5 |
| 5 s-hex71 | (Lm⁻²h⁻¹bar⁻¹) | | | | | |
| Thickness: <15 nm | | | | | | |
| | Salt rejection | — | 99.69 ± 0.01 | 99.7 ± 0.1 | 98.5 ± 0.1 | 36.6 ± 1.8 |
| | (%) | | | | | |
| PIP-2.0%-0.1%- | Water permeance | 30.1 ± 2.6 | 20.1 ± 1.1 | 21.1 ± 1.1 | 17.7 ± 0.8 | 24.8 ± 1.5 |
| 5 s-hex71 | (Lm⁻²h⁻¹bar⁻¹) | | | | | |
| Thickness: <13 nm | Salt rejection | — | 99.82 ± 0.04 | 99.7 ± 0.1 | 98.0 ± 0.2 | 28.3 ± 2.0 |
| | (%) | | | | | |
| PIP-2.0%-0.15%- | Water permeance | 37.8 ± 1.5 | 22.1 ± 0.3 | 24.9 ± 0.4 | 20.8 ± 0.4 | 31.5 ± 1.3 |
| 5 s-hex71 | (Lm⁻²h⁻¹bar⁻¹) | | | | | |
| Thickness: <10 nm | Salt rejection | — | 99.70 ± 0.1 | 99.2 ± 0.4 | 93.2 ± 1.0 | 19.1 ± 2.0 |
| | (%) | | | | | |
| PIP-0.05%-0.15%- | Water permeance | 79.5 ± 6.3 | 33.6 ± 2.6 | 53.0 ± 6.0 | 71.6 ± 6.8 | 62.2 ± 4.7 |
| 5 s-hex71 | (Lm⁻²h⁻¹bar⁻¹) | | | | | |
| Thickness: <6 nm | Salt rejection | — | 81.09 ± 6.5 | 39.9 ± 11.4 | 4.0 ± 1.8 | 3.2 ± 0.9 |
| | (%) | | | | | |
| PIP-0.05%-0.1%- | Water permeance | 63.7 ± 4.0 | 30.3 ± 1.1 | 56.9 ± 1.3 | 56.7 ± 4.0 | 55.9 ± 3.1 |
| 60 s-hex71 | (Lm⁻²h⁻¹bar⁻¹) | | | | | |
| Thickness: <9 nm | Salt rejection | — | 98.83 ± 0.3 | 85.5 ± 1.3 | 11.0 ± 2.7 | 10.3 ± 1.2 |
| | (%) | | | | | |
| PIP-0.1%-0.15%- | Water permeance | 60.2 ± 2.2 | 29.0 ± 1.4 | 40.5 ± 0.9 | 49.3 ± 0.6 | 47.5 ± 0.7 |
| 5 s-hex71 | (Lm⁻²h⁻¹bar⁻¹) | | | | | |
| Thickness: <9 nm | Salt rejection | — | 98.55 ± 0.47 | 89.8 ± 3.1 | 26.8 ± 1.8 | 10.3 ± 3.4 |
| | (%) | | | | | |
| PIP-0.1%-0.15%- | Water permeance | 50.5 ± 3.9 | 25.4 ± 2.2 | 51.6 ± 4.0 | 36.2 ± 4.1 | 44.1 ± 3.1 |
| 60 s-hex71 | (Lm⁻²h⁻¹bar⁻¹) | | | | | |
| Thickness: <10 nm | Salt rejection | — | 99.2 ± 0.3 | 96.2 ± 0.8 | 57.7 ± 8.0 | 10.3 ± 0.7 |
| | (%) | | | | | |
| PIP-1.0%-0.15%- | Water permeance | 49.6 ± 0.8 | 26.4 ± 0.6 | 33.0 ± 0.7 | 28.4 ± 0.8 | 39.8 ± 0.9 |
| 5 s-hex71 | Lm⁻²h⁻¹bar⁻¹ | | | | | |
| Thickness: <10 nm | Salt rejection | — | 99.37 ± 0.2 | 98.3 ± 0.2 | 83.2 ± 1.1 | 12.3 ± 2.0 |
| | (%) | | | | | |
| PIP-1.0%-0.15%- | Water permeance | 54.1 ± 1.3 | 26.7 ± 0.1 | 51.0 ± 1.9 | 46.5 ± 3.0 | 47.9 ± 0.5 |
| 60 s-hex71 | (Lm⁻²h⁻¹bar⁻¹) | | | | | |
| Thickness: <10 nm | Salt rejection | — | 98.70 ± 0.3 | 90.2 ± 1.3 | 19.4 ± 3.8 | 11.1 ± 0.7 |
| | (%) | | | | | |
| NCM-0.025%-0.05% | Water permeance | 25.1 | 21.9 | 22.6 | 22.9 | — |
| Thickness: 12 nm | (Lm⁻²h⁻¹bar⁻¹) | | | | | |
| (ref 1) | Salt rejection | — | 99.1 | 97.5 | 44.3 | 27.5 |
| | (%) | | | | | |
| PEI-TMC @ | Water permeance | 32.7 | 18.1 | 17.2 | 20.1 | 24.8 |
| pH 6.5 | (Lm⁻²h⁻¹bar⁻¹) | | | | | |
| Thickness: 77.4 nm | Salt rejection | — | 71.0 | 79.4 | 86.4 | 54.3 |
| (ref 2) | (%) | | | | | |
| BHTTM/PIP | Water permeance | 13.2 | 99.5 ± 0.4 | 95.0 ± 1.3 | — | 30.0 ± 1.2 |
| (After | (Lm⁻²h⁻¹bar⁻¹) | | | | | |
| oxidation) | Salt rejection | — | 12.0 ± 0.5 | 10.9 ± 0.3 | — | 12.1 ± 0.3 |
| Thickness: 91.0 nm | (%) | | | | | |
| (ref 3) | | | | | | |
| NF 3 (PIP/0.09 wt | Water permeance | 16.7 | — | — | — | — |
| % Sericin-TMC) | (Lm⁻²h⁻¹bar⁻¹) | | | | | |
| Thickness: 128.0 nm | Salt rejection | — | 95.8 | — | — | 26.3 |
| (ref 4) | (%) | | | | | |
| PA50/CNC/PES | Water permeance | — | — | — | — | 32.3 |
| Thickness: 145.0 nm | (Lm⁻²h⁻¹bar⁻¹) | | | | | |
| (ref 5) | Salt rejection | — | 97.7 | 86.0 | 15.5 | 6.5 |
| | (%) | | | | | |

### Example 13

### Inductively Coupled Plasma Mass Spectrometry (ICP-MS) and Ion Chromatography (IC)

Inductively coupled plasma mass spectrometry (Perkin Elmer, Optima 2000 instrument) was used to detect magnesium and sodium ions at low concentration. The concentration of the sample was determined from the calibration curves of that particular ion. Sample was prepared by maintaining ionic strength in the range of 0.3 to 10 ppm. Ion chromatography (DIONEX ICS-5000⁺ DC) instrument was used to quantify the sulphate and chloride ions in the sample. Sample with concentration in the range between 0.1 to 10 ppm was studied. In all cases samples were analyzed after necessary dilution.

### Example 14

Calculation of Ideal Ion Selectivity (Cl⁻ to SO₄²⁻) from the Measured Salt Rejection of Individual Pure Salt Solution as Feed

Nanofiltration performance of the nanofilm composite membranes was evaluated separately by using pure salt (NaCl and Na₂SO₄) as feed with a concentration of 2 g/L under 5 bar applied pressure at 25 (±1) ° C. temperature and a cross-flow velocity of 50 L/h. Ionic strengths of anions and cations present in the feed and permeate was measured by IC and ICP analyses to calculate ideal ion selectivity based on equation (iii).

TABLE 4
Nanofiltration performance of the nanofilm composite membranes. Calculated
ideal ion selectivity (Cl⁻ to SO₄²⁻). Individual salt solution (Na₂
SO₄ and NaCl) as a feed of concentration 2 g/L was used for the experiments.
Nanofilm was made via interfacial polymerization and washed with hexane.

| | Membrane performance in individual pure salt | | | |
|---|---|---|---|---|
| Polyamide nanofilm | solution as feed | | | Ideal ion |
| (amine w/w %-TMC | PWP* | Rejection of | Rejection of | selectivity |
| w/w %-IP time) | (LMH bar) | SO₄²(%) | Cl⁻(%) | (Cl⁻ to SO₄²⁻) |
| PIP-2.0%-0.05%-5 s-hex71 | 23.2 ± 1.7 | 99.69 ± 0.01 | 36.6 ± 1.8 | 204.5 |
| PIP-2.0%-0.1%-5 s-hex71 | 30.1 ± 2.6 | 99.82 ± 0.04 | 28.3 ± 2.0 | 398.0 |
| PIP-1.0%-0.1%-5 s-hex71 | 37.1 ± 2.0 | 99.76 ± 0.13 | 25.1 ± 3.8 | 312.0 |
| PIP-2.0%-0.15%-5 s-hex71 | 37.8 ± 1.5 | 99.70 ± 0.12 | 19.1 ± 2.0 | 269.7 |

*PWP = Pure water permeance expressed as liters m−² hour−¹ bar−¹ (LMH bar)

### Example 15

Measurement of Ion Selectivity (Cl⁻ to SO₄²⁻ and Na⁺ to Mg²⁺) from Mixed Salt Solution

Nanofiltration performance of the nanofilm composite membranes in mixed salt solution as feed was used to measure ion selectivity. In one feed, Na₂SO₄ and NaCl were mixed together to measure Cl⁻ to SO₄²⁻ selectivity and in a second feed, MgCl₂ and NaCl were used for measuring Na⁺ to Mg²⁺ selectivity. Individual salt of 1 g/L each i.e. a total of 2 g/L was used in the feed. Membranes were tested under 5 bar applied pressure at 25 (±1) ° C. temperature and at a cross-flow velocity of 50 L/h.

TABLE 5
Nanofiltration performance of the nanofilm composite membranes.
Measurement of ion selectivity (Cl⁻ to SO₄²⁻ and Na⁺ to
Mg²⁺) from mixed salt solution as feed. Mixed salt solutions (feed 1:
Na₂SO₄: 1 g/L and NaCl: 1 g/L and feed 2: MgCl₂: 1 g/L and NaCl:
1 g/L) were used where the total salt concentration in the feed was 2 g/L.
Nanofilm was made via interfacial polymerization and washed with hexane.

| | Nanofiltration performance in | | | | Nanofiltration performance in | | | |
|---|---|---|---|---|---|---|---|---|
| Polyamide | mixed salt (feed 1) | | | | mixed salt (feed 2) | | | |
| nanofilm | | | | Mixed | | | | Mixed |
| (amine | | | | ion | | | | ion |
| w/w %-TMC | WP* | Rejection | Rejection | selectivity | WP* | Rejection | Rejection | selectivity |
| w/w %-IP | (LMH | of SO₄²⁻ | of Cl⁻ | (Cl⁻ to | (LMH | of Mg²⁺ | of Na⁺ | (Na⁺ to |
| time) | bar) | (%) | (%) | SO₄²⁻) | bar) | (%) | (%) | Mg²⁺) |
| PIP-2.0%- | 18.7 ± 1.4 | 99.94 ± 0.01 | 24.6 ± 3.1 | 1256.6 | 17.3 ± 1.1 | 99.57 ± 0.16 | −6.2 ± 5.8 | 246.9 |
| 0.05%-5 s- | | | | | | | | |
| hex71 | | | | | | | | |
| PIP-2.0%- | 23.0 ± 1.3 | 99.93 ± 0.01 | 12.5 ± 2.9 | 1250.0 | 20.8 ± 1.1 | 99.19 ± 0.13 | −22.0 ± 5.9 | 150.6 |
| 0.1%-5 s- | | | | | | | | |
| hex71 | | | | | | | | |
| PIP-1.0%- | 29.2 ± 1.3 | 99.82 ± 0.12 | 13.9 ± 7.5 | 478.3 | 28.6 ± 1.4 | 94.23 ± 1.2 | −36.1 ± 5.8 | 23.6 |
| 0.1%-5 s- | | | | | | | | |
| hex71 | | | | | | | | |
| PIP-2.0%- | 28.7 ± 0.7 | 99.53 ± 0.44 | −7.1 ± 4.9 | 228.0 | 25.4 ± 0.6 | 95.0 ± 0.9 | 1.2 ± 3.4 | 19.8 |
| 0.15%-5 s- | | | | | | | | |
| hex71 | | | | | | | | |

*WP = Water permeance expressed as liters m⁻² hour⁻¹ bar⁻¹ (LMH bar)

### Example 16

Measurement of Ion Selectivity (SO₄²⁻ to Cl⁻) from Sea Water as Feed

Nanofiltration performance of the nanofilm composite membranes in synthetic sea water (used salts concentrations are NaCl: 24.5 g/L, MgCl₂: 5.2 g/L, Na₂SO₄: 4.09 g/L, CaCl₂: 1.16 g/L and KCl: 0.695 g/L) was tested under 10 bar applied pressure at 25 (±1) ° C. temperature and a crossflow velocity of 50 L/h. Note that, the calculated permeance in LMHbar⁻¹ at 10 bar is lower than the calculated permeance in LMHbar⁻¹ at 5 bar.

TABLE 6
Nanofiltration performance of the nanofilm composite membranes.
Measurement of ion selectivity (Cl⁻ to SO₄²⁻ and
Na⁺ to Mg²⁺) from synthetic sea water feed. Nanofilm
was made via interfacial polymerization and washed with hexane.

| Polyamide | | | | | | | Ion | Ion |
|---|---|---|---|---|---|---|---|---|
| nanofilm | | | | | | | selectivity | selectivity |
| (amine | | Membrane performance in synthetic sea water feed | | | | | from sea | from sea |
| w/w %-TMC | PWP* | WP* | Rejection | Rejection | Rejection | Rejection | water feed | water feed |
| w/w %-IP | (LMH | (LMH | of SO₄²⁻ | of Cl⁻ | of Mg²⁺ | of Na⁺ | (Cl⁻ to | (Na⁺ to |
| time) | bar) | bar) | (%) | (%) | (%) | (%) | SO₄²) | Mg²⁺) |
| PIP-2.0%- | 22.0 ± 1.5 | 5.6 ± 0.3 | 99.84 ± 0.06 | 23.2 ± 2.3 | 98.86 ± 0.02 | 9.4 ± 0.8 | 480 | 79.5 |
| 0.05%-5 s- | | | | | | | | |
| hex71 | | | | | | | | |
| PIP-2.0%- | 25.7 ± 1.6 | 6.2 ± 0.3 | 99.35 ± 0.49 | 21.7 ± 1.5 | 97.9 ± 0.6 | 10.4 ± 1.4 | 120.5 | 42.7 |
| 0.1%-5 s- | | | | | | | | |
| hex71 | | | | | | | | |
| PIP-1.0%- | 33.0 ± 1.1 | 9.5 ± 0.4 | 98.79 ± 0.53 | 18.6 ± 1.6 | 94.3 ± 0.9 | 7.2 ± 2.1 | 67.3 | 16.3 |
| 0.1%-5 s- | | | | | | | | |
| hex71 | | | | | | | | |

*PWP = Pure water permeance and WP = water permeance are expressed as liters m⁻² hour⁻¹ bar⁻¹ (LMH bar)

### Example 17

### X-Ray Photoelectron Spectroscopic (XPS) Study

Polymer nanofilms were made freestanding and transferred onto a PLATYPUS™ gold coated silicon wafer as described above. The gold coated silicon wafer containing nanofilm was then dried at room temperature, washed in methanol and finally dried in a hot air oven at a temperature of 50° C. for 30 min. The XPS analysis was carried out using an Omicron Nanotechnology spectrometer using 300 W monochromatic AlKα X-ray as excitation source. The survey spectra and core level XPS spectra were recorded from at least three different spots on the samples. The analyzer was operated at constant pass energy of 20 eV and setting the C1s peak at BE 285 eV to overcome any sample charging. Data processing was performed using CasaXps. Peak areas were measured after satellite subtraction and background subtraction either with a linear background or following the methods of Shirley. (D. A. Shirley, High-resolution X-ray photoemission spectrum of the valence bands of gold, Phys. Rev. B 5, 4709, 1972).

### Example 18

Measurement of Degree of Network Crosslinking of the Nanofilms from the XPS Study

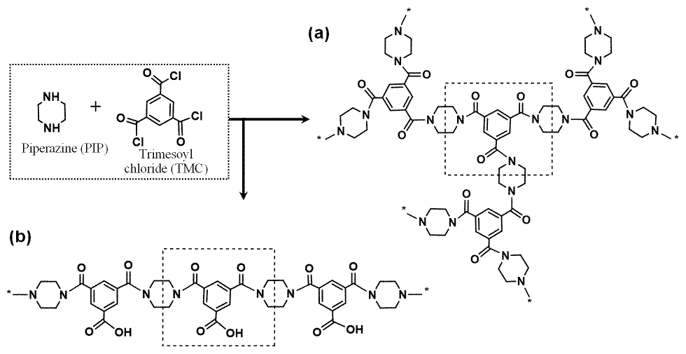

During interfacial polymerization, there will be a probability of having both network crosslinking and linear crosslinking branch exist in the polymer. The degree of network crosslinking is a measure of the amount of network crosslinked part in the polymer. Chemical structure of a fully aromatic polyamide formed via interfacial polymerization is shown in FIG. 4. From the XPS study, the elemental composition of carbon (C), nitrogen (N) and oxygen (O) was determined. Based on the elemental composition, the degree of network crosslinking (DNC) is calculated following the formula given in US20180170003A1,

$$D N C = \frac{X}{X + Y} \times 100 \% \\ where \qquad ( iv )$$

$$\frac{O}{N} = \frac{3 X + 4 Y}{3 X + 2 Y} \qquad ( v )$$

Polyamide nanofilm was prepared via interfacial polymerization of PIP and TMC and reacted for 5 s on PAN support. Excess hexane solution containing TMC was removed soon after the reaction and the unreacted TMC remained on the nanofilm surface was further removed by washing with pure hexane and dried at room temperature for 30 s. The composite membrane was finally annealed at 70° C. for 1 min in a hot air oven. Results are shown in Table 7.

TABLE 7
Chemical composition and surface properties
of freestanding polymer nanofilms

| | Atomic composition estimated | | | Degree of |
|---|---|---|---|---|
| | from XPS (%) | | | network |
| | Carbon | Nitrogen | Oxygen | Crosslinking |
| Nanofilms | (C) | (N) | (O) | DNC (%) |
| PIP-0.1%-0.1%-5 s-hex71 | 76.86 | 9.74 | 13.40 | 52.5 |
| PIP-1.0%-0.1%-5 s-hex71 | 74.54 | 12.33 | 13.11 | 90.8 |

### Advantages of the Invention

Highly permeable ultrathin polymer nanofilm composite membrane has the following advantages:

1. Nanofilm composite membranes presented herein are made via interfacial polymerization which is commonly used for large scale industrial membrane production and used for desalination. The process produces the polymer nanofilm of thickness less than 5 nm.
2. Nanofilm composite membranes presented herein are washed with solvents to decrease its thickness and the transmembrane resistance and to improve the nanofiltration performance. This includes the high rejection of both anion (SO₄⁻) and cation (Mg²⁺) with high water permeance.
3. Nanofilm composite membranes presented herein have the unique features with tunable salt rejection properties, increased water permeability, and high monovalent to multivalent ion selectivity.
4. Nanofilm composite membranes presented herein exhibit up to 99.82% rejection of Na₂SO₄ and demonstrate extremely high water permeability of 79.5 LMHbar⁻¹.
5. Nanofilm composite membranes presented herein also exhibit very high rejection (up to 98.5%) of MgCl₂ and very low rejection of NaCl (19.1%).
6. Nanofilm composite membranes presented herein separates ions from the mixed salts and exhibits high ion selectivity of more than 1200.
7. Nanofilm composite membranes presented herein exhibit the permeance beyond the state-of-the-art nanofiltration membranes and much higher than the commercially available membranes.

1-9. (canceled)

10. A highly permeable ultrathin polymer nanofilm composite membrane comprising:
i. a base layer of porous polymer support membrane; and
ii. an upper polymer nanofilm;
wherein the polymer nanofilm is made via interfacial polymerization and thickness of the polymer nanofilm is in the range of 4 nm to 50 nm;
wherein the upper polymer nanofilm comprises a crosslinked or linear polyamide comprising a diamine or a polyamine in an aqueous phase with a concentration in the range of 0.01 to 5 w/w % and a polyfunctional acid halide in an organic phase with a concentration in the range of 0.01 to 0.5 w/w %.

11. The membrane as claimed in claim 10, wherein the diamine or polyamine is selected from the group consisting of piperazine (PIP), m-phenylenediamine (MPD), p-phenylenediamine (PPD), polyethyleneimine (PEI), 4-(Aminomethyl)piperidine (AMP), 1,3-cyclohexane diamine (CDA13), 1,4-cyclohexane diamine (CDA14), 1,6-hexanediamine (HDA), ethylene diamine (EDA),

12. The membrane as claimed in claim 10, wherein the polyfunctional acid halide is selected from the group consisting of trimesoyl chloride (TMC) or terephthaloyl chloride (TPC).

13. The membrane as claimed in claim 10, wherein the nanofilm has a degree of network crosslinking is in the range of 52.5 to 90.8% and zeta potential of the nanofilm is in the range of −20 to −30 mV.

14. The membrane as claimed in claim 10, wherein the base layer of porous polymer support membrane is selected from the group consisting of hydrolyzed Polyacrylonitrile (HPAN), polysulfone (PSF), polyethersulfone (PES), P84 and polyacrylonitrile (PAN).

15. The membrane as claimed in claim 10, wherein the membrane exhibits Na₂SO₄ rejections in the range of 81% to 99.82% with high value of pure water permeance in the range of 30 LMHbar⁻¹ to 79.5 LMHbar⁻¹.

16. The membrane as claimed in claim 10, wherein the membrane exhibits pure water permeance in the range of 23.2 LMHbar⁻¹ to 79.5 LMHbar⁻¹ with a rejection of MgCl₂ and NaCl in the range of 4% to 98.5% and 3% to 36.6% respectively.

17. The membrane as claimed in claim 10, wherein the nanofilm has an elemental composition of: 76.86% carbon, 13.40% oxygen and 9.74% nitrogen and 52.5% of a degree of network crosslinking; or: 74.54% carbon, 13.11% oxygen, and 12.33% nitrogen and 90.8% of a degree of network crosslinking in case of polymer repeating unit selected from piperazine and trimesoyl chloride.

18. A process for the preparation of the highly permeable ultrathin polymer nanofilm composite membrane comprising the steps of:
i. preparing a polymer support membrane via phase inversion method on a nonwoven fabric;
ii. modifying the polymer support membrane as obtained in step (i) to obtain a hydrophilic support;
iii. pouring aqueous solution containing a diamine or polyamine with a concentration in the range of 0.01 to 5.0 w/w % on top of the polymer support membrane as obtained in step (i) or (ii) followed by soaking for 10 seconds to 1 minute;
iv. discarding the aqueous solution from the polymer support membrane and removing the remaining aqueous solution with a rubber roller followed by air drying for 10 seconds to 1 minute;
v. immediately contacting organic solution containing polyfunctional acid halide with a concentration in the range of 0.01 to 0.5 w/w % with the polymer support membrane of step (iv) for a period in the range of 5 seconds to 5 min for interfacial polymerization to obtain a nanofilm;
vi. removing excess organic solution followed by removing unreacted polyfunctional acid halide remaining on the nanofilm by washing with a solvent and drying the membrane at room temperature for 10 to 30 seconds;
vii. annealing the membrane at a temperature in the range of 40 to 90° C. for a period in the range of 1 to 10 min to obtain the highly permeable ultrathin polymer nanofilm composite membrane.

19. The process as claimed in claim 18, wherein in step (iii), the diamine or polyamine is selected from the group consisting of piperazine (PIP), m-phenylenediamine (MPD), p-phenylenediamine (PPD), polyethyleneimine (PEI), 4-(Aminomethyl) piperidine (AMP), 1,3-cyclohexane diamine (CDA13), 1,4-cyclohexane diamine (CDA14), 1,6-hexanediamine (HDA), ethylene diamine (EDA).

20. The process as claimed in claim 18, wherein in step (v) the polyfunctional acid halide used is selected from trimesoyl chloride (TMC) or terephthaloyl chloride (TPC).

21. The process as claimed in claim 18, wherein in step (vi), the solvent used is selected from the group consisting of hexane, toluene, xylene, acetone, methanol, ethanol, propanol, isopropanol, water, dimethylformamide (DMF), dimethylacetamide (DMAc), N-methylpyrrolidone (NMP), acetonitrile either alone or combination thereof.
